(19) United States
(12) Patent Application Publication
(10) Pub. No.: US 2025/0314501 A1
(43) Pub. Date: Oct. 9, 2025

(54) Method and Apparatus for Providing Navigation Data from a Backend Server to a Vehicle During a Driving Process

(71) Applicant: Bayerische Motoren Werke Aktiengesellschaft, Muenchen (DE)

(72) Inventors: Stefan Holder, Muenchen (DE); Martin Wernwag, Garching (DE)

(21) Appl. No.: 18/862,921

(22) PCT Filed: Feb. 24, 2023
(86) PCT No.: PCT/EP2023/054662

§ 371 Date: Nov. 4, 2024

(30) Foreign Application Priority Data
May 16, 2022 (DE) 10 2022 112 170.4

(51) Int. Cl. G01C 21/36; G01C 21/34

(52) U.S. Cl. CPC G01C 21/3617; G01C 21/3415

(57) ABSTRACT

A method for providing navigation data from a backend server to a vehicle includes transmitting a request message from the vehicle to the backend server for a first quantity of navigation data, and receiving the first quantity of navigation data from the backend server in response. The first quantity of navigation data includes a quantity of decision points. The method includes determining a traversal of a decision point from the decision points by the vehicle. If the decision point has been traversed, then transmitting another request message from the vehicle to the backend server to request a second quantity of navigation data, and receiving the second quantity of navigation data from the backend server.

The present application is the U.S. national phase of PCT Application PCT/EP2023/054662 filed on Feb. 24, 2023, which claims priority of German patent application No. 10 2022 110 170.4 filed on May 16, 2022, the entire contents of which are incorporated herein by reference.

### TECHNICAL FIELD

The disclosure relates to a method for providing navigation data from a backend server to a vehicle while driving the vehicle. The disclosure further relates to a computer-readable medium for providing navigation data from a backend server to a vehicle during a journey with the vehicle, a system for providing navigation data from a backend server to a vehicle during a journey with the vehicle, as well as a vehicle containing the system for providing navigation data from a backend server to a vehicle during a journey with the vehicle.

### BACKGROUND

It is known to predict a destination of a vehicle and transmit it to a vehicle. This can result in the destination of the vehicle being available in the vehicle with a delay.

Therefore a need exists to provide navigation data to a vehicle more efficiently. In particular, there is a need to more efficiently control the provision of navigation data, in particular one or more decision points and/or one or more navigation destinations, from a backend server to a vehicle.

### SUMMARY

At least some embodiments described and claimed herein address the above-stated needs, as well as others.

A first aspect is a method for providing navigation data from a backend server to a vehicle while driving the vehicle. The method can be a computer-implemented method and/or a control device-implemented method. Navigation data can contain a quantity of destinations and/or a quantity of decision points. A destination in the quantity of destinations is preferably a predicted destination which is predicted by the backend server, for example using historical destinations of the vehicle. A decision point from the quantity of decision points can be a waypoint at which the driven routes of the vehicle branch off to different destinations. The method can be carried out at the beginning of a journey and continuously during the journey. The vehicle can be a land vehicle. For example, the vehicle can be a motor vehicle or a motorcycle.

The method includes transmitting a first request message from the vehicle to the backend server to request a first quantity of navigation data. For example, the first request message can be transmitted at the beginning of the journey with the vehicle. Furthermore, the method includes receiving the first quantity of navigation data by the vehicle from the backend server in response to the first request message, wherein the first quantity of navigation data includes a first quantity of decision points. The method determines a traversal of a decision point from the first quantity of decision points by the vehicle. If a decision point from the first quantity of decision points has been traversed, the method transmits a second request message from the vehicle to the backend server to request a second quantity of navigation data. Finally, the method receives the second quantity of navigation data from the backend server in response to the second request message from the vehicle.

Advantageously, the method can request navigation data more efficiently from a backend server. When the vehicle traverses a decision point, the method can again request navigation data from the backend server. This allows the method to provide navigation data more quickly at relevant points in a journey—the decision points. Furthermore, the method can efficiently control a request of the navigation data from the backend server. In detail, an efficient request of navigation data can be characterized in that a response of the backend server with the navigation data differs from a previous response of the backend server. At decision points, there is preferably a particularly high probability that responses of the backend server and thus the navigation data that the backend server transmits to the vehicle will differ. By using decision points to request navigation data, updates to the navigation data can be efficiently transmitted from the backend server to the vehicle. Unnecessary requests by the vehicle for navigation data from the backend server can thus be efficiently avoided.

According to an advantageous design, the first quantity of navigation data can include a first quantity of destinations and a first quantity of decision points. The decision point can be a decision point from the first quantity of decision points. This allows the method to efficiently request navigation destinations and decision points from the backend server.

In a further advantageous design, the second quantity of navigation data can include a second quantity of destinations and/or a second quantity of decision points. The second quantity of navigation data can preferably include the second quantity of decision points if the second quantity of decision points is different from the first quantity of decision points. This allows the method to efficiently update destinations and/or decision points to the vehicle after traversing a decision point. Changes to the destinations and the decision points after traversing a decision point of the first quantity of decision points can be quickly transferred from the backend server to the vehicle. Thus, the vehicle can receive current (predicted) destinations from the backend server. At the same time, the vehicle can receive updated decision points that can be used to control one or more further requests to the backend server.

According to another advantageous design, the first quantity of destinations may include one or more predicted destinations, and/or the second quantity of destinations may contain one or more predicted destinations. Each predicted destination can include a probability that indicates the probability with which the predicted destination is correct. The backend server can predict one or more destinations using known methods and can determine the probability of each of the predicted destinations. A probability of a predicted destination and/or a predicted destination can change after traversing a decision point. By requesting navigation data that includes one or more predicted destinations after traversing a decision point, the vehicle can efficiently request predicted destinations from the backend server and/or can update predicted destinations already available on the vehicle.

According to another advantageous design, a decision point can be a waypoint of multiple routes driven by the vehicle at which the multiple routes driven by the vehicle branch off to different destinations. With this the requesting of further decision points or further quantities of decision points can be efficiently controlled.

According to another advantageous design, a decision point of the first quantity of decision points can be traversed if the vehicle first enters a first specified circle around the decision point and then exits a second specified circle around the decision point. With this the traversal of a decision point can be determined more reliably.

According to another advantageous design, a radius of the first circle can be smaller than a radius of the second circle, and/or the vehicle can receive the radius of the first circle and the radius of the second circle for each decision point with the first quantity of decision points from the backend server. With this the traversal of a decision point can be determined more reliably.

According to another advantageous design, the method can also include the backend server receiving the first request message from the vehicle to request the first quantity of navigation data, the backend server determining a first quantity of destinations of the first quantity of navigation data, the backend server determining a first quantity of decision points of the first quantity of navigation data, a reduction of a number of decision points of the first quantity of decision points by the backend server, and transmission of the first quantity of navigation data including the reduced first quantity of decision points and the first quantity of destinations from the backend server to the vehicle in response to the first request message. With this the first quantity of navigation data including the first quantity of decision points and the first quantity of destinations can be determined efficiently.

According to another advantageous design, reducing the number of decision points of the first quantity of decision points can include filtering the first quantity of decision points depending on the importance of the decision points, and/or merging decision points that lie within a specified radius or multiple specified radii of circles around a position of the decision point, and/or determining a specified, maximum number of decision points for the first quantity of decision points depending on the importance of the decision point, and/or determining a specified maximum number of decision points for the first quantity of decision points depending on the distance of the decision point from the vehicle. With this the first quantity of decision points can be determined efficiently. In particular, a number of decision points in the first quantity of decision points can be controlled efficiently.

According to another advantageous design, the first quantity of destinations of the first quantity of navigation data may include one or more destinations of the routes of the vehicle and/or the first quantity of destinations of the first quantity of navigation data may include one or more destinations of the routes of the vehicle depending on the current position of the vehicle and/or the current direction of travel of the vehicle. This can be used to efficiently determine the first quantity of destinations.

According to another advantageous design, the method can include transmitting a third request message from the vehicle to the backend server to request a third quantity of navigation data depending on a distance of a current position of the vehicle from a decision point from the first or second quantity of decision points, and/or transmitting a third request message from the vehicle to the backend server to request a third quantity of navigation data if a last request exceeds a specified amount of time, and/or suppressing the first request message, the second request message, and/or the third request message from the vehicle to the backend server to provide the first quantity, the second quantity, and/or the third quantity of navigation data if a distance of the vehicle from a next decision point falls below a specified distance threshold and/or a period of time to reach the next decision point falls below a specified time threshold. With this a time to transmit a request message from the vehicle to the backend server can be controlled efficiently. Unnecessary requests to the backend server can be efficiently avoided.

Another aspect is characterized by a computer-readable medium for providing a quantity of navigation data from a backend server to a vehicle during a journey with the vehicle, wherein the computer-readable medium contains instructions which, when executed on a control unit and/or a computer, carry out the method described above.

Another aspect is characterized by a system for providing a quantity of navigation data from a backend server to a vehicle during a journey with the vehicle, wherein the system is designed to carry out the method described above.

Yet another aspect is characterized by a vehicle containing the system described above for providing a quantity of navigation data from a backend server to a vehicle while driving the vehicle.

Further features result from the claims, the figures and the description of the figures. All the features and combinations of features mentioned above in the description as well as the features and combinations of features mentioned below in the description of the figures and/or shown in the figures alone can be used not only in the respective specified combination, but also in other combinations or on their own.

### BRIEF DESCRIPTION OF THE DRAWINGS

FIG. 1 shows an exemplary method for providing a quantity of navigation data,

FIG. 2 shows an exemplary scenario for determining a traversal of a decision point

FIG. 3 shows a first scenario with predicted destinations and decision points at the beginning of a journey, and

FIG. 4 shows a second scenario with predicted destinations and decision points during the journey.

### DETAILED DESCRIPTION

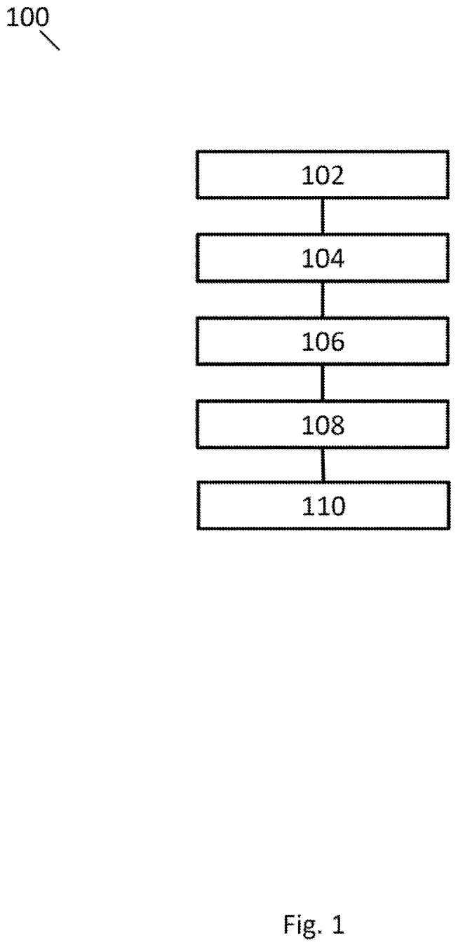

In detail, FIG. 1 shows a method 100 for providing a quantity of navigation data from a backend server to a vehicle during a journey with the vehicle. The method 100 can transmit 102 a first request message from the vehicle to the backend server to request a first quantity of navigation data. The first quantity of navigation data preferably includes a first quantity of destinations, in particular predicted destinations, and/or a first quantity of decision points. The vehicle can transmit the first request message to the backend server at the beginning of a journey. The first request message may include a position of the vehicle, in particular a current position of the vehicle, and/or time information. The time information can include, for example, a current departure time, a planned departure time, a time after the start of the journey, or a time when the first request message was transmitted to the backend server. Preferably, the vehicle can transmit the position of the vehicle and/or the time information to the backend server with each request message. The time information can optionally be transmitted by the vehicle with each request.

The backend server can receive the first request message from the vehicle to request the first quantity of navigation data. The first quantity of navigation data can include a first quantity of destinations, in particular a first quantity of predicted destinations, and a first quantity of decision points. Next, the backend server can determine the first quantity of navigation data. In detail, the backend server can determine the first quantity of destinations, in particular the first quantity of predicted destinations, the first quantity of navigation data, and the first quantity of decision points of the first quantity of navigation data. The first quantity of destinations can include one or more predicted destinations, which the backend server predicts, for example, at the beginning of the journey with the vehicle. The backend server can predict one or more destinations depending on the position of the vehicle and/or the time information received from the vehicle with the first request message. Furthermore, the backend server can predict one or more destinations using historical destinations. Preferably, the backend server determines a probability for each predicted destination which is representative of the correctness of the prediction of the destination. Furthermore, the backend server can determine the first quantity of decision points of the first quantity of navigation data. The first quantity of decision points can be determined by the backend server using historical driven routes of the vehicle. After each journey with the vehicle, the vehicle can transmit the route driven to the backend server. The backend server can receive the route of the vehicle after each journey with the vehicle. The driven route of the vehicle can include a quantity of vehicle positions determined by the vehicle by means of a satellite-based positioning system. Furthermore, the vehicle can transmit time information for each route driven to the backend server at a beginning, at an end, and/or at each vehicle position of the route driven. The backend server can determine positions for waypoints at which the driven routes branch off from the routes driven by the vehicle and/or from a user of the vehicle. A waypoint at which the driven routes of the vehicle branch off can be a decision point of the first quantity of decision points.

The backend server can reduce a number of decision points of the first quantity of decision points. To reduce the number of decision points, the backend server can use different methods, which are described below.

The backend server can calculate an importance for each decision point. Using the importance, the backend server can filter decision points. For example, the backend server can only add decision points to the first quantity of decision points with importance exceeding a specified minimum importance threshold.

In addition or alternatively, a maximum number of decision points can be specified for the first quantity of decision points. If a maximum number of decision points is specified for the first quantity of decision points, the decision points with the greatest importance can be determined up to the maximum number and added to the quantity of decision points. Alternatively, the decision points closest to the current vehicle position can be determined up to the maximum number and added to the quantity of decision points.

A decision point can include a position of a waypoint. For example, the position of the waypoint can be specified as a latitude and longitude coordinate.

Furthermore, the backend server can reduce the number of decision points by only considering decision points that are at a shorter distance than a specified maximum distance from the current vehicle position. Alternatively, decision points with the shortest distance from the current vehicle position can be determined up to a maximum number.

Preferably, the importance of a decision point indicates the probability that traversing the decision point will result in a different destination being suggested to the user. The following formula is used:

$$p ( other destination after EP ) = {\sum }_{i = 1}^{n} p ( {out\_path}_{i} ) \times important\_update ( {out\_path}_{i} )$$

wherein
p(out_pathᵢ) is the conditional probability of leaving the decision point EP by the path out_pathᵢ under the condition that the decision point EP has been reached; and
important_update(out_pathᵢ) is 1 if another destination is suggested to the user after traversing the decision point, otherwise 0. Preferably, a minimum probability of the most likely destination is taken into account, from which, for example, a navigation system of the vehicle is automatically started. In this case, there is also an important change if the minimum probability is only reached when traversing the decision point via out_pathᵢ or if the minimum probability is no longer reached after traversing the decision point via out_pathᵢ.

Furthermore, the importance of a decision point defined above can be multiplied by the probability of reaching the decision point from the current vehicle position.

Alternatively, the importance of a decision point indicates the information gain with regard to a predicted destination to be expected from the decision point.

For example, the importance of the decision point can be calculated by the use of an expected value of the information gain as follows:

$$E [ IG ( X ) ] = {\sum }_{dEDx} P ( d ) \cdot ( H ( Z ) - H ( Z / d ) ) ,$$

wherein
X is a decision point;
IG the information gain;
Dₓ is a quantity of possible traversals through the decision point X; a traversal d is defined by an incoming road segment and an outgoing road segment at a junction, such as an intersection or roundabout;
P(d): is the probability of traversing d the decision point X from a current vehicle position;
Z: are target probabilities at the current vehicle position;
Z|d: are target probabilities after traversing d the decision point X; and
H: is the entropy.

The sum of the probabilities of all traversals of a decision point Σ_{dEDx} P(d) corresponds to the probability of traversing decision point X from the current vehicle position in any way.

Instead of calculating the importance of decision points and filtering decision points based thereon, the following simple method can be used as an alternative. Only routes driven by the vehicle which have a specified minimum probability of 0.1, for example, are taken into account when calculating decision points. Alternatively, only the most probable routes up to a maximum number of routes are taken into account when calculating decision points. Both methods ensure that only the most important decision points are taken into account.

The backend server can transmit the reduced, first quantity of decision points and/or the first quantity of destinations, in particular the first quantity of predicted destinations, to the vehicle as the first quantity of navigation data in response to the first request message.

Further, the method 100 can receive 104 the first quantity of navigation data from the backend server in response to the first request message from the vehicle. The first quantity of navigation data can include the first quantity of destinations and/or the first quantity of decision points. If the quantity of destinations includes one destination, this destination is a predicted destination with the greatest probability. If the quantity of destinations includes multiple destinations, these destinations are predicted destinations for which the backend server has determined the greatest probability. The received destinations from the first quantity of destinations can be made available to a user of the vehicle on a display device of the vehicle and/or a mobile terminal. The user can select a displayed destination by means of an operating input and can activate destination guidance of the navigation system of the vehicle and/or of the mobile terminal.

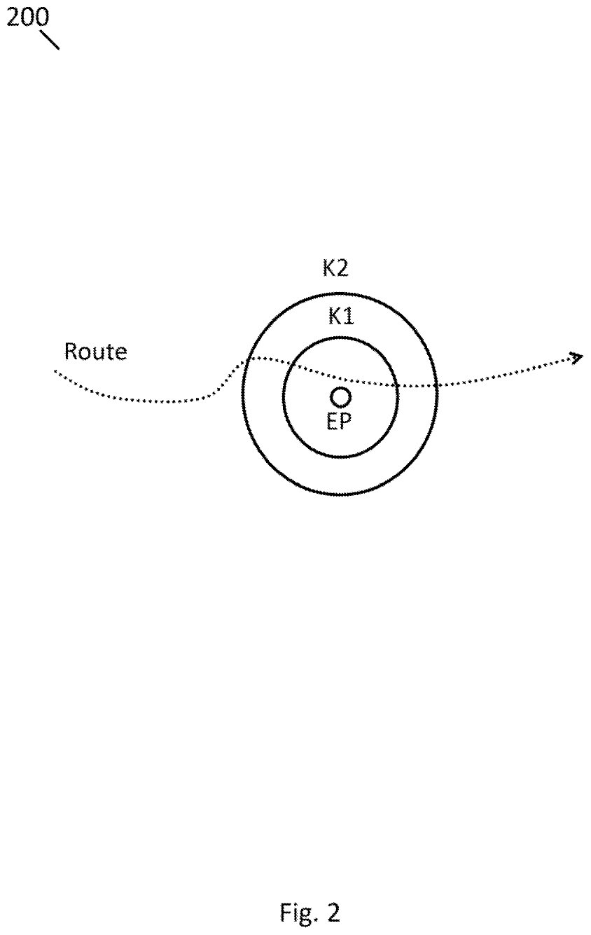

Furthermore, the method 100 can determine 106 a traversal of a decision point from the first quantity of decision points by the vehicle. In detail, FIG. 2 shows an example scenario 200 for determining a traversal of a decision point EP. A decision point EP can be considered to have been traversed in the present method 100 if the vehicle (not shown in FIG. 2) first enters a circle K1 along a route driven by the vehicle and then leaves a circle K2. The circle K1 and the circle K2 are preferably circles that have a decision point EP as their center.

Furthermore, a radius of the circle K1 is smaller than a radius of the circle K2. For example, the radius of circle K1 can be 90 m, and the radius of circle K2 can be 100 m, for example. The radii of the circles K1 and K2 can be specified individually for each decision point. Alternatively, the radii of circles K1 and K2 can be the same for all decision points. The two circles K1 and K2 can form a hysteresis function that prevents entering a circle in the event of an inaccurate signal of a satellite-based positioning system and prevents falsely detecting an exit from the circle at a short time interval due to the inaccurate signal from the satellite-based positioning system. Transmitting individual radii for each decision point can have the advantage that multiple decision points can be merged into one decision point with larger radii for circles K1 and K2. For example, a number of decision points can be reduced by merging adjacent decision points into one decision point by increasing the radii of circles K1 and K2 of a decision point.

The first quantity of decision points and/or the destination or destinations received from the backend server can be updated by the method 100 during the journey with the vehicle. In particular, a current vehicle position and/or a previously driven route can be information that can be used by the backend server to determine the destinations more precisely and to provide updated destinations to the vehicle. Updating the quantity of navigation data, in particular the quantity of destinations and/or the quantity of decision points, can be done by using a traversed decision point from the first quantity of decision points.

In detail, the method 100 can transmit 108 a second request message to the backend server from the vehicle to request a second quantity of navigation data and can receive 110 the second quantity of navigation data from the backend server in response to the second prediction request by the vehicle if a decision point from the first quantity of decision points has been traversed. The second quantity of navigation data can include a second quantity of destinations and/or a second quantity of decision points. Preferably, the second quantity of navigation data includes the second quantity of destinations, in particular the second quantity of predicted destinations. Optionally, the second quantity of navigation data can include the second quantity of decision points. If the second quantity of navigation data includes only the quantity of destinations, the vehicle can efficiently receive new or changed predicted destinations from the backend server. The user of the vehicle receives the predicted destinations provided by the backend server that are most probable from the first quantity of decision points after traversing the decision point. If there are additional or changed decision points on the backend server after traversing the decision point from the first quantity of decision points, the second quantity of navigation data can include the second quantity of decision points. Thus, the second quantity of navigation data can also be used to update the first quantity of decision points.

Each time a traversal of a decision point occurs, the vehicle can transmit another request message, such as a third, a fourth, and/or a fifth request message, to the backend server and can receive a third, fourth, and/or fifth quantity of navigation data in response to each additional request message. For example, the transmission of further request messages can be repeated until a maximum number of request messages have been transmitted and/or a maximum time has elapsed since the start of the journey with the vehicle.

In addition, the method 100 can transmit one or more request messages from the vehicle to the backend server on a time-controlled basis to provide another quantity of navigation data. For example, the vehicle can transmit a request message to the backend server under time control at cyclic intervals, for example every 10 minutes. A time-controlled request message from the vehicle to provide an additional quantity of navigation data has the advantage that even if there is a small number of decision points in the quantity of decision points, requests are regularly transmitted to the backend server and as a result current destinations and/or a current quantity of decision points are transmitted from the backend server to the vehicle. The vehicle can thus always receive current destinations and/or a current quantity of decision points from the backend server. Furthermore, the method 100 can prevent the transmission of one or more time-controlled request messages before the vehicle traverses a decision point. The method 100 can prevent a time-controlled request message from being transmitted from the vehicle to the backend server if the vehicle is closer than a specified distance, for example 1000 m, from a decision point. In addition or alternatively, the method 100 can prevent the transmission of a time-controlled request message from the vehicle to the backend server if an estimated time to reach a decision point is less than a specified threshold, for example less than 3 minutes. For example, to calculate the estimated time, a straight line or a route length from a current position of the vehicle to a decision point can be used to estimate how long the time to reach the decision point is expected to last.

By preventing one or more time-controlled requests from being transmitted, requests from the vehicle to the backend server can be prevented over a longer period of time, such as 10, 20, 30, . . . , 50 min, even if no decision point is traversed by the vehicle. This can occur, for example, if there are a large number of decision points in the vicinity, i.e. within the specified distance from one or more decision points of a route of the vehicle that prevent one or more timed requests from the vehicle to the backend server. The vehicle can transmit a time-controlled request message from the vehicle to the backend server if a specified maximum time, for example 10 minutes, has elapsed since a last request from the vehicle to the backend server. This can prevent the vehicle from transmitting no request to provide another predicted destination and another quantity of decision points from the vehicle to the backend server for an extended period of time.

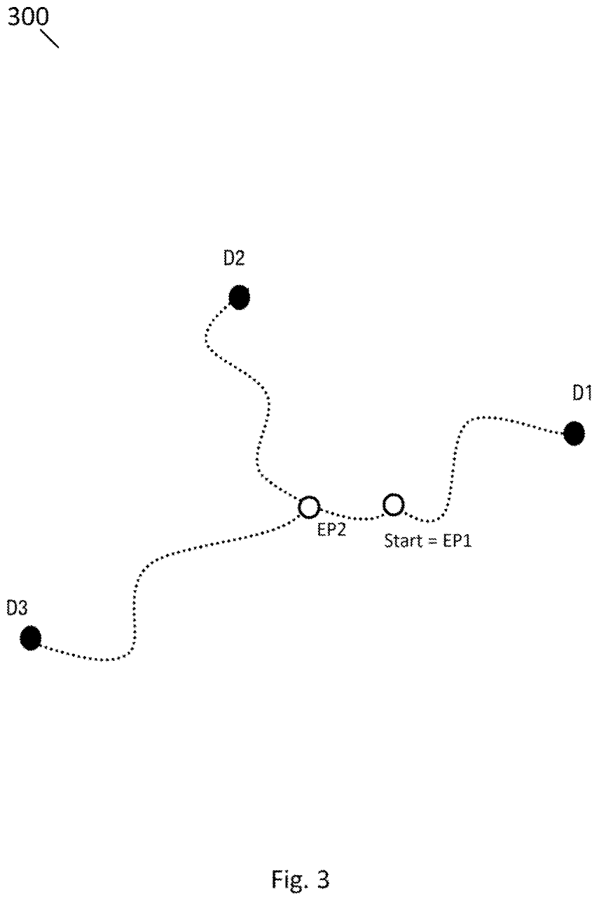

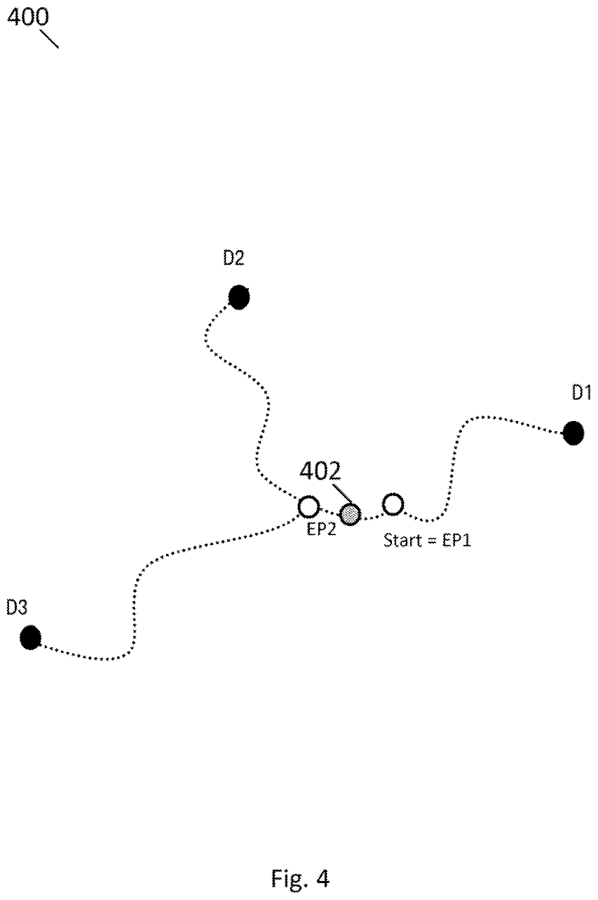

FIG. 3 shows a first scenario 300 with destinations and decision points at the beginning of a journey. FIG. 4 shows a second scenario 400 with destinations and decision points during the journey. Each of the scenarios 300 and 400 includes three destinations D1, D2, and D3, four predicted routes R1, R2, R3, and R4, as well as two decision points EP1 and EP2. The vehicle starts the journey at decision point EP1. At the beginning of the journey, the three destinations D1, D2, and D3 are possible destinations of the vehicle starting from the decision point EP1. Furthermore, a first quantity of decision points includes the decision points EP1 and EP2. At the beginning of the journey, the vehicle can receive the three destinations and the first quantity of decision points from the backend server. The vehicle 402 is driving from EP1 towards EP2. The vehicle can determine a traversal of the decision point EP1. If the decision point EP1 has been traversed by the vehicle, the vehicle can transmit a second request message to the backend server. After the traversal of EP1 in the direction of EP2, the backend server can determine the two destinations D2 and D3 as still possible destinations of the vehicle. A second quantity of decision points can include, for example, the decision point EP2. The two destinations D2 and D3 can be made available to the user of the vehicle. By means of an operating input, the user can select one of the two destinations and can carry out destination guidance of the navigation system of the vehicle and/or of a mobile terminal to the selected destination.

Advantageously, the method can efficiently improve a transmission of predicted destinations. After a traversal of a decision point, a prediction of which destination the vehicle is currently heading to can be efficiently improved. At relevant waypoints, the decision points, the vehicle transmits a request message to the backend server during a journey. The number of requests to the backend server can be efficiently reduced compared to purely time-controlled methods and at the same time the quantity of decision points and/or destinations can be efficiently kept up to date. The user thus receives more correctly provided predictions of destinations. At the same time, unnecessary requests from the vehicle to the backend server can be avoided. This can lead to the fact that a required bandwidth when transmitting the data between the backend server and the vehicle can be efficiently reduced.

### LIST OF REFERENCE SIGNS

100 method
102 transmitting a first request message
104 receiving a first quantity of navigation data
106 determining a traversal of a decision point
108 transmitting a second request message
110 receiving a second quantity of navigation data
200 scenario
EP decision point
K1 circle
K2 circle
300 first scenario
400 second scenario
402 vehicle.

1.-14. (canceled)

15. A method for providing navigation data from a backend server to a vehicle during a journey with the vehicle, the method including:
transmitting a first request message from the vehicle to the backend server to request a first quantity of navigation data;
receiving the first quantity of navigation data by the vehicle from the backend server in response to the first request message, wherein the first quantity of navigation data includes a first quantity of decision points;
determining a traversal of a decision point from the first quantity of decision points by the vehicle; and
responsive at least in part to the decision point from the first quantity of decision points being traversed:
transmitting a second request message from the vehicle to the backend server to request a second quantity of navigation data; and
receiving the second quantity of navigation data by the vehicle from the backend server in response to the second request message.

16. The method as claimed in claim 15, wherein the first quantity of navigation data includes a first quantity of destinations and a first quantity of decision points.

17. The method as claimed in claim 16, wherein the second quantity of navigation data includes at least one of the group consisting of a second quantity of destinations and a second quantity of decision points.

18. The method as claimed in claim 17, wherein the second quantity of navigation data preferably includes the second quantity of decision points if the second quantity of decision points is different from the first quantity of decision points.

19. The method as claimed in claim 16, wherein the second quantity of navigation data includes a second quantity of destinations, and wherein:
the first quantity of destinations includes one or more predicted destinations; or
the second quantity of destinations includes one or more predicted destinations.

20. The method as claimed in claim 15, wherein a decision point is a waypoint of multiple routes driven by the vehicle, at which the multiple routes driven by the vehicle branch off to different destinations.

21. The method as claimed in claim 15, wherein the decision point of the first quantity of decision points has been traversed if the vehicle first enters a first specified circle around the decision point and then exits a second specified circle around the decision point.

22. The method as claimed in claim 21, wherein a radius of the first specified circle is smaller than a radius of the second specified circle.

23. The method as claimed in claim 22, wherein the vehicle receives the radius of the first specified circle and the radius of the second specified circle for each decision point with the first quantity of decision points from the backend server.

24. The method as claimed in claim 21, wherein the vehicle receives a radius of the first specified circle and a radius of the second specified circle for each decision point with the first quantity of decision points from the backend server.

25. The method as claimed in claim 15, further comprising:
receiving the first request message to request the first quantity of navigation data from the vehicle by the backend server;
determining a first quantity of destinations of the first quantity of navigation data by the backend server;
determining a first quantity of decision points of the first quantity of navigation data by the backend server;
reducing a number of decision points of the first quantity of decision points by the backend server; and
transmitting the first quantity of navigation data including the reduced first quantity of decision points and the first quantity of destinations from the backend server to the vehicle in response to the first request message.

26. The method as claimed in claim 25, wherein reducing the number of decision points of the first quantity of decision points includes at least one of the group consisting of:
filtering the first quantity of decision points depending on an importance of the decision points;
merging decision points that lie within a specified radius or multiple specified radii of circles around a position of the decision point;
determining a specified maximum number of decision points for the first quantity of decision points depending on the importance of the decision point; and
determining a specified maximum number of decision points for the first quantity of decision points depending on the distance of the decision point from the vehicle.

27. The method as claimed in claim 25, wherein the first quantity of destinations of the first quantity of navigation data includes one or more destinations of routes driven by the vehicle;

28. The method as claimed in claim 25, wherein the first quantity of destinations of the first quantity of navigation data includes one or more destinations of routes driven by the vehicle depending at least in part on a current position of the vehicle or a current direction of travel of the vehicle.

29. The method as claimed in claim 15, further comprising:
transmitting a third request message from the vehicle to the backend server to request a third quantity of navigation data depending on a distance of a current position of the vehicle from a decision point from the first quantity of decision points or the second quantity of decision points; or
transmitting a third request message from the vehicle to the backend server to request a third quantity of navigation data if a last request exceeds a specified period of time; or
suppressing the first request message, the second request message, or the third request message from the vehicle to the backend server at least in part based on whether a distance of the vehicle from a next decision point falls below a specified distance threshold or a period of time to reach the next decision point falls below a specified time threshold.

30. A non-transitory computer-readable medium for providing a quantity of navigation data from a backend server to a vehicle during a journey with the vehicle, wherein the non-transitory computer-readable medium contains instructions which, when executed on a control unit or a computer, carry out the method as claimed in claim 15.

31. A system for providing a quantity of navigation data from a backend server to a vehicle during a journey with the vehicle, wherein the system is designed to carry out the method as claimed in claim 15.

32. A vehicle containing the system for providing a quantity of navigation data from a backend server to a vehicle during a journey with the vehicle as claimed in claim 31.

33. A method for providing navigation data from a backend server to a vehicle during a journey, comprising:
receiving from the vehicle a first request message to request a first quantity of navigation data by the backend server;
determining a first quantity of destinations of the first quantity of navigation data by the backend server;
determining a first quantity of decision points of the first quantity of navigation data by the backend server;
reducing a number of decision points of the first quantity of decision points by the backend server; and
transmitting the first quantity of navigation data including the reduced first quantity of decision points and the first quantity of destinations from the backend server to the vehicle in response to the first request message.

34. The method as claimed in claim 33, wherein reducing the number of decision points of the first quantity of decision points includes at least one of the group consisting of:
filtering the first quantity of decision points depending on an importance of the decision points;
merging decision points that lie within a specified radius or multiple specified radii of circles around a position of the decision point;
determining a specified maximum number of decision points for the first quantity of decision points depending on the importance of the decision point; and
determining a specified maximum number of decision points for the first quantity of decision points depending on the distance of the decision point from the vehicle
